(19) United States
(12) Patent Application Publication
(10) Pub. No.: US 2016/0161320 A1
(43) Pub. Date: Jun. 9, 2016

(54) Limit Level Measuring Device

(71) Applicant: Vega Grieshaber KG, Wolfach (DE)

(72) Inventors: Gerd OHMAYER, Haslach (DE); Jochen GRISCHKAT, Aichhalden (DE); Daniel SCHREMPP, Bad Rippoldsau (DE)

(21) Appl. No.: 14/865,070

(22) Filed: Sep. 25, 2015

(30) Foreign Application Priority Data
Dec. 9, 2014 (EP) 14 197 005.3

(51) Int. Cl. G01F 23/28

(52) U.S. Cl. CPC G01F 23/28

(57) ABSTRACT

Limit level measurement device for monitoring the level of contents with a sensor that can be mounted to a container where the limit level sensor has a protective housing which at least partially surrounds and/or covers the mechanical oscillator.

### CROSS REFERENCE TO RELATED APPLICATIONS

This patent application claims priority to European Patent Application 14 197 005.3, filed on Dec. 9, 2014.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

1. Field of the Invention

The invention relates to limit level measurement device.

2. Background of the Invention

Limit level measurement devices are known from prior art. Appropriate limit level sensors, such as oscillation limit level sensors have for example a piezoelectric or magnetic drive, by which a limit level sensor membrane can be set into oscillation. There is a mechanical oscillator on the membrane opposite the drive which oscillates in response to a medium, such as air, at a predetermined frequency. If the mechanical oscillator is covered by the contents of the container, the oscillation is dampened and the damping action is registered by the sensor. In this manner, the sensor coverage can detect the contents and the limit level can be recognized.

With such limit level measurement devices the problem is that, among other things, when there is medium wave movement inside the container or with mediums that tend to foam, it can lead to errors, because both a wavelike covering and foam on the limit level sensor will dampen the oscillation of the mechanical oscillator and lead to an incorrect measurement.

From prior art, it is therefore known that both fill level as well as limit level measurement applications are arranged in a bypass, that is a riser that communicates with the container but is otherwise separated from it. Such an arrangement is shown in FIG. 1. FIG. 1 shows a container 6 with liquid contents 8 in container 6 which, due to a mechanical agitator, for example, shows wave movement. In the illustrative embodiment shown in FIG. 1 there is a so-called bypass 81 fitted laterally to the container 6, which stays connected with the container 6 via an upper connection 82 and a lower connection 83. Connections 82 and 83 form communicating tubes, so that a full level in the bypass 81 corresponds with the prevailing level in the container 6. This way, a limit level measurement can be recorded in the bypass 81 using the fitted limit level sensors 3, while ignoring the wave formation in the container 6. The same approach may also be appropriate for contents that tend to foam.

The embodiment described above is considered disadvantageous and that a structure with a bypass is very costly and cannot be utilized in every application. Particularly in confined spatial conditions, fitting a bypass may not only be possible or desired due to cost reasons but also due to space.

The purpose of the present invention is to develop a limit level measurement assembly that is preferably inexpensive, and is easy to install even for applications with wave and/or foaming and/or negative working currents.

This purpose is achieved by a limit level measurement device having the features described herein. By means of a protective housing, also described herein, a supplied limit level sensor can be retrofitted according to the invention.

### BRIEF SUMMARY OF THE INVENTION

In a preferred embodiment, a limit level measurement device for monitoring the level of contents with a sensor that is mounted to a container comprising a limit level sensor with a protective housing which at least partially surrounds a mechanical oscillator.

In another preferred embodiment, the limit level measurement device as described herein, further comprising wherein the mechanical oscillator can be set to oscillation via a membrane that is activated by a drive and has at least one mechanical oscillator on the membrane and is covered and surrounded by the protective housing in the installed state at least on the front and side surfaces.

In another preferred embodiment, the limit level measurement device as described herein, wherein the mechanical oscillator which, in the installed state, is covered by the protective housing on the upper side or underside.

In another preferred embodiment, the limit level measurement device as described herein, wherein the protective housing is made up of at least four contiguous areas of a cuboid, each of which is joined to at least two other surfaces.

In another preferred embodiment, the limit level measurement device as described herein, wherein the mechanical oscillator is completely surrounded by the protective housing and is covered on the front side.

In another preferred embodiment, the limit level measurement device as described herein, wherein the protective housing is designed as a cylinder that is closed on at least on one side.

In another preferred embodiment, the limit level measurement device as described herein, wherein the protective housing has a partially open or perforated structure.

In another preferred embodiment, the limit level measurement device as described herein, wherein the perforated structure has a uniform arrangement of multiple, circular holes formed with a diameter of at least 4 millimeters.

In another preferred embodiment, the limit level measurement device as described herein, wherein the protective housing is made of metal and designed as a bent part.

In another preferred embodiment, the limit level measurement device as described herein, wherein the protective housing is designed as a plastic injection molded part.

In another preferred embodiment, the limit level measurement device as described herein, wherein the protective housing is attached to a fastening device of the limit level sensor by a separate fastening means.

In another preferred embodiment, the limit level measurement device as described herein, wherein the protective housing has a distance of at least 10 millimeters in the axial direction apart from the mechanical oscillator.

In another preferred embodiment, the limit level measurement device as described herein, further comprising an inner diameter of the protective housing or a distance between opposite side surfaces of the protective housing of at least 30 to 40 millimeters.

In another preferred embodiment, the limit level measurement device as described herein, wherein the protective housing at least partially covers the mechanical oscillator.

In another preferred embodiment, the limit level measurement device as described herein, wherein the protective housing is designed as a stamped-bent part.

In another preferred embodiment, the limit level measurement device as described herein, wherein the inner diameter of the protective housing or distance between opposite side surfaces of the protective housing is 35 millimeters.

In another preferred embodiment, a protective housing for a mechanical oscillator of a limit level sensor of a limit level measurement device according the descriptions herein.

In another preferred embodiment the protective housing as described herein, wherein the protective housing is a retrofit part.

### BRIEF DESCRIPTION OF THE DRAWINGS

FIG. 1 is a line drawing evidencing a container with a limit level measurement device arranged in a bypass according to prior art.

FIG. 2 is a line drawing evidencing a side view of a first illustrative embodiment of a limit level measurement device with a protective housing.

FIG. 3 is a line drawing evidencing the limit level measurement device of FIG. 2 in a perspective view from an angle below.

FIG. 4 is a line drawing evidencing a side view of a second illustrative embodiment of a limit level measurement device.

FIG. 5 is a line drawing evidencing a perspective view of the limit level measurement device of FIG. 4.

### DETAILED DESCRIPTION OF THE INVENTION

The present invention relates to a limit level measurement device for monitoring the limit level of contents with a mountable limit level sensor inside a container and with a membrane that can be set to oscillation and at least one mechanical oscillator fitted to the membrane, where the limit level sensor features at least a partially encompassing and/or a generally protective housing for one of the mechanical oscillators.

An appropriate protective housing is advantageously designed to block or dampen occurring waves and/or occurring foam and possibly any currents from the mechanical oscillator so that these negative influences are masked during level limit detection. With at least a partially encompassing and/or a general protective housing, flooding the mechanical oscillator due to wave buildup or foam covering the sensor can be avoided so that these influences are well hidden during measurement.

Terms like sideways, front side, top side, bottom side assume an axial direction in the present application of the limit level sensor, which is defined by a longitudinal extension of the mechanical oscillator, which is oriented in the axial direction toward the free end of the mechanical oscillator as the front side, where laterally refers to the sides and top and bottom sides are perpendicular towards a rising or falling fill level.

It must be noted that in all embodiments of the invention the filling medium can stay in contact with the limit level sensor's mechanical oscillator through the protective housing so that an overall limit level measurement remains possible.

In one embodiment of the limit level measurement arrangement, the installed mechanical oscillator, is at least laterally and on the front side surrounded and overlapped by the protective housing, which means that in the installed state a kind of protection collar is formed by the protective housing, which can particularly keep waves and/or foam away from the mechanical oscillator.

When installed, the oscillator can be covered by the protective housing on the upper side and lower side.

In a particularly simple embodiment, the protective housing is formed as an element of at least four contiguous areas of a cuboid where each of the sides are joined by at least two other sides. With such a protective housing, which may be attached, for example, using the protective housing fastening means, to the container and/or the limit level sensor, the mechanical oscillator, for example, can be covered on the front side, side and top side so that wave triggered measurement errors in particular can be avoided.

Furthermore, the mechanical oscillator can be completely surrounded by the protective housing and advantageously covered on the front side. In such an embodiment where the protective housing can be comprised of a cylinder closed on at least one side, in particular a circular cylinder, effective protection against disrupting influences during level detection can also be achieved. Particularly in the case of a circular cylindrical base of the protective housing, and a tubular configured arrangement adjacent thereto, a rotationally symmetrical design of the protective housing can be achieved which, when it is mounted in the axial direction of the limit level sensor, requires no additional alignment.

The protective housing may have at least a partial perforated structure in order to ensure that the medium has access to the mechanical oscillator. With such a perforated structure waves can correspondingly be damped and foams are held back, so that measurement errors are avoided.

The perforated structure can be formed, for example, in a uniform arrangement of multiple preferably circular holes with a diameter of preferably at least four millimeters. Particularly, if the protective housing is made of metal, a so-called perforated plate may be used for production, which provides a particularly advantageous production alternative.

To ensure that the protective housing is optimally corrosion resistant, it can be made preferably of metal, such as stainless steel. Manufacturing can be inexpensive if the protective housing in this case is constructed as a bent part, preferably as a stamped-bent part. Particularly as a stamped-bent part, the protective housing can be easily manufactured.

Depending on the intended area of application for the limit level measurement arrangement, the protective housing can also be designed as an injection molded part, preferably as a plastic injection molded part. In an embodiment with an injection molded part, in particular injection-molded plastic, inexpensive production is possible.

To easily attach the protective housing, it may be coupled with a fastening device on the limit level sensor and/or its own means of attachment. For example, the protective housing can be attached using a nut by which the limit level sensor is mounted on a container wall, along with a lock nut which can be glued or welded. The protective housing's own fasteners may be in the protective housing's mounting holes, for example.

To ensure correct operation of the limit level sensor, the protective housing should be in the axial direction of the mechanical oscillator, preferably at least ten millimeters apart.

The inner diameter of the protective housing or distance between opposite side walls of the protective housing is at least 30 to 40 millimeters, preferably 35 millimeters, so that laterally and perpendicular thereto, there is a minimum distance of at least 10 millimeters between the mechanical oscillator and the protective housing.

A protective housing according to the invention for a limit level sensor mechanical oscillator of a limit level measurement device is designed in accordance with any preceding claim.

It is advantageous if the protective housing is designed as a retrofit part, so that existing limit level measurement devices or limit level sensors can be configured with an appropriate protective housing.

### DETAILED DESCRIPTION OF THE FIGURES

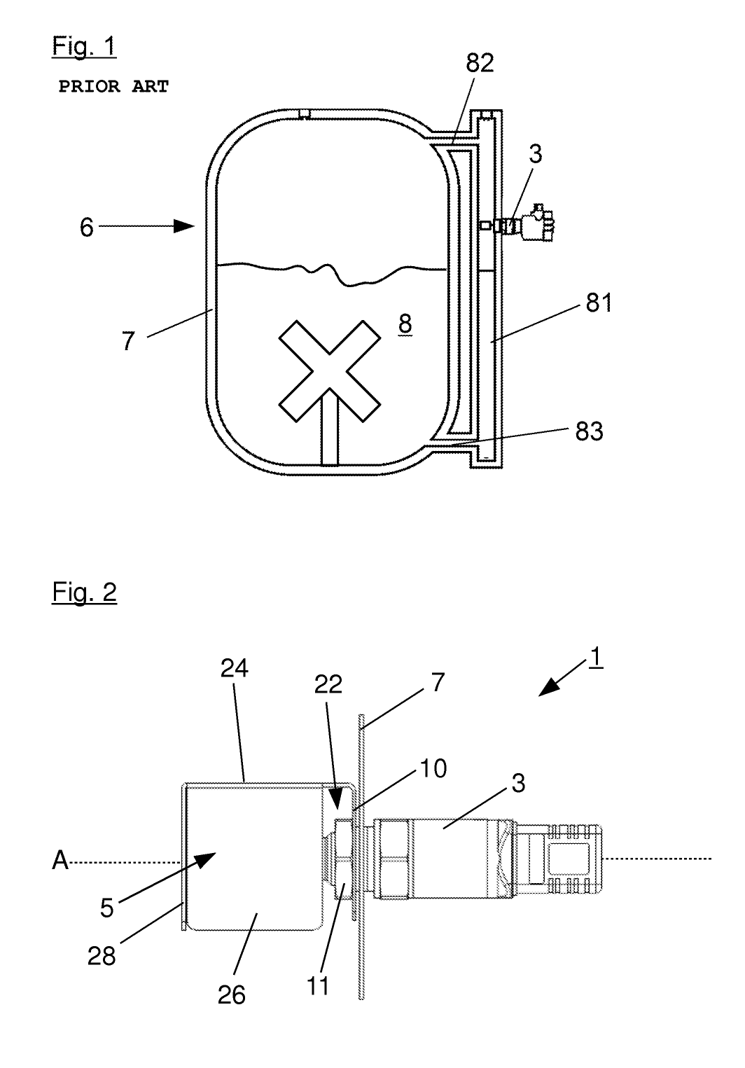

FIG. 1 is intended only to show the state of prior art as described herein.

FIG. 2 shows a side view of a first illustrative embodiment of a limit level measurement device 1 of the present application.

The limit level measurement device 1 is essentially made of a limit level sensor 3 arranged on a partially illustrated container wall 7 as well as a protective housing 5 surrounding the limit level sensor 3 mechanical oscillator 9. The limit level sensor 3 defined by its longitudinal extent in axial direction A, which is used in the present illustrative embodiment, for a more detailed description of the location of the specified components of the limit level sensor 3 as well as of the protective housing 5 relative to each other. The mechanical oscillator 9 is fitted to the limit level sensor orientated to the front , that is in the axial direction and in the direction of the housing interior. The mechanical oscillator 9 may for example be set to oscillation via a membrane activated by a drive within the limit level sensor 3, such as a piezo drive or an electromagnetically operating drive. The mechanical oscillator 9 shown in the FIG. 2 illustrative embodiment, is enclosed by the protective housing 5 on both the front and the sides, which in this case is fitted to the limit level sensor 3 using a mounting bracket 10. The mounting bracket 10, as shown in FIG. 2, is supported by means of a fastening device 11, which is embodied here as a nut.

The protective housing 5 is presently configured such that the top surface 24 of the protective housing extends from the mounting bracket 10 over the mechanical oscillator 9 from which the first side surface 26 and the second side surface 27 extend vertically downwards, so that the mechanical oscillator 9 is covered as the side view illustrates in FIG. 2. The mechanical oscillator 9 in this case is surrounded by the protective housing 5 both on the upper side and laterally. On the front side the protective housing 5 overlaps the mechanical oscillator such that the front surface 28 on the front side also extends vertically downwards.

In the present illustrative embodiment, the side surfaces 26, 27 are configured such that between the mounting bracket 10 and the side surfaces 26, there is an opening 22, through which a tool can be inserted to tighten the nut 11. Additionally or alternatively, to attaching the protective housing 5 via the fastening device 11 of the limit level sensor 3, there are additional fastening means 13, such as holes, which can be used for securing the protective housing 5 separately. With such fastening means 13 the protective housing could be secured irrespective of the limit level sensor 3 attachment to the container wall 7.

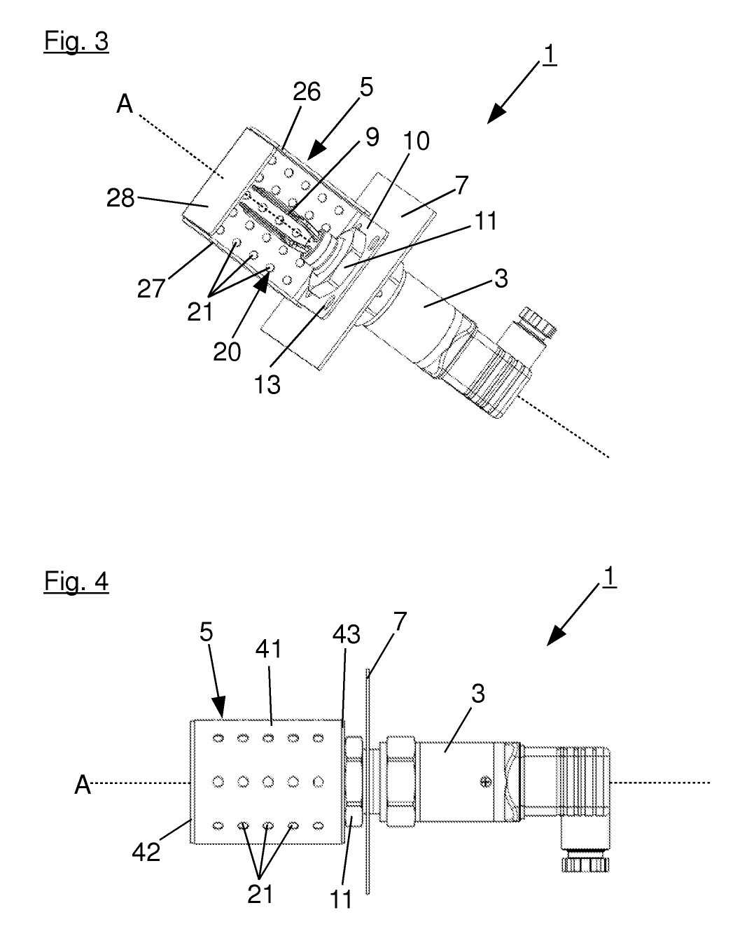

A perspective view of the arrangement from FIG. 2 is shown in FIG. 3.

From FIG. 3, it appears particularly clear that the protective housing 5 can easily be made as a stamped-bent part according to the present embodiment. Both the mounting bracket 10 and the top, side and front surfaces 24, 26, 27, 28 are bent from a single sheet metal part that was stamped out in the appropriate shape. A bottom surface 25, that is, a top opposite parallel-facing surface, which would cover the mechanical oscillator 9 from below, is not provided in the present illustrative embodiment. The top surface 24 in the present illustrative embodiment also shows multiple organized circular holes 21, forming a perforated structure. Such a perforated structure 20 can ensure that a medium entering from the bottom area of the mechanical oscillator 9 can also emerge again on the upper side.

The arrangement shown can be used, for example, to prevent incorrect measurements due to wave movement inside the container. Depending on the specific application, an arrangement may also be useful where the bottom surface is fitted with a perforated structure 20.

Such a protective housing can be manufactured easily if it is made without a bottom surface, since a form of the embodiment shown in FIG. 2 above, can be made with only four 90 degree bends that were previously stamped out, waterjet cut or by using any other available cutting method. This way, a solution to the problems known from prior art, that has a simple structure, is stable, easy to produce, easy to install, inexpensive and corrosion resistant, can be made available. In particular, it can be manufactured in one piece, so that there is no unnecessary increase in the number of components needed.

FIG. 4 shows the side view of a limit level measurement device 1 with an alternative embodiment of the protective housing 5.

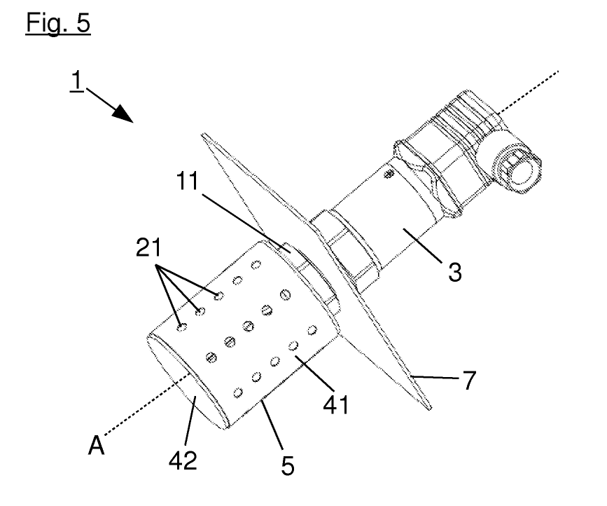

In this illustrative embodiment, the protective housing 5 is shown as a protective cage, where the protective cage design is essentially cylindrical. On a cylindrical surface 42 fitted to the front side of the mechanical oscillator 9, a cylinder barrel 41 with a hole 21 perforated structure is connected, which is closed off on the back end with a rear surface 43 and an opening for the mechanical oscillator. The cylindrical surface 42 is shown in a circular shape in the present illustrative embodiment, as is more apparent in FIG. 5, so that the protective housing 5 essentially has the shape of a circular cylinder.

On the rear surface 43 of the protective housing 5, the nut has been fitted as a fastening device 11 for attaching or welding the limit level sensor 3. The cylinder barrel 41 may be configured in the present illustrative embodiment, both as a perforated pipe segment as well as a round curved and longitudinally welded perforated sheet. The cylinder barrel 41 is connected or welded all around on front side with the cylindrical surface 42 and on the back with the back surface 43, for example, so that it is essentially a closed design except for the perforated structure.

FIG. 5 shows the limit level measurement device 1 shown in FIG. 4 in a perspective view. From this view, the circular configuration of the cylindrical surface 42 and the resulting circular-cylindrical shape of the protective housing 5, can be seen.

Combining the fastening device 11 with the protective housing 5, provides a reduction in the needed components. With the rotationally symmetric design of the protective housing 5, it can further be achieved that no particular orientation of the protective device 5, which can be mounted to the limit level sensor 3 for example, is necessary. Tests have shown that, to ensure error free operation of the mechanical oscillator 9, a circumferential distance of at least ten millimeters in the axial direction from the protective housing to the mechanical oscillator 9 is required. A maintained diameter of at least 25 to 45 millimeters is required with preferably 35 millimeters. See also the corresponding claim.

It should be noted at this point that the above illustrative embodiments are designed with metal, and that the present invention is not limited to this choice of materials. Rather, it is also possible to create corresponding designs for a protective housing made of plastic, such as injection molded parts for example, which can advantageously be used accordingly.

### LIST OF REFERENCE NUMBERS

1 Limit level measurement device
3 Limit level sensor
5 Protective housing
6 Container
7 Container wall
8 Contents
9 Mechanical oscillator
10 Mounting bracket
11 Fastening device, nut
13 Fasting means, holes
20 Perforated structure
21 Holes
22 Opening
24 Top surface
25 Bottom surface
26 First side surface
27 Second side surface
28 Front surface
41 Cylinder barrel
42 Cylinder surface
43 Back surface
81 Bypass
82 Upper connection
83 Lower connection
A Axial direction

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A limit level measurement device for monitoring the level of contents with a sensor that is mounted to a container comprising a limit level sensor with a protective housing which at least partially surrounds a mechanical oscillator.

2. The limit level measurement device of claim 1, further comprising wherein the mechanical oscillator can be set to oscillation via a membrane that is activated by a drive and has at least one mechanical oscillator on the membrane and is covered and surrounded by the protective housing in the installed state at least on the front and side surfaces.

3. The limit level measurement device of claim 2, wherein the mechanical oscillator which, in the installed state, is covered by the protective housing on the upper side or underside.

4. The limit level measurement device of claim 2, wherein the protective housing is made up of at least four contiguous areas of a cuboid, each of which is joined to at least two other surfaces.

5. The limit level measurement device of claim 1, wherein the mechanical oscillator is completely surrounded by the protective housing and is covered on the front side.

6. The limit level measurement device of claim 5, wherein the protective housing is designed as a cylinder that is closed on at least on one side.

7. The limit level measurement device of claim 1, wherein the protective housing has a partially open or perforated structure.

8. The limit level measurement device of claim 7, wherein the perforated structure has a uniform arrangement of multiple, circular holes formed with a diameter of at least 4 millimeters.

9. The limit level measurement device of claim 1, wherein the protective housing is made of metal and designed as a bent part.

10. The limit level measurement device of claim 1, wherein the protective housing is designed as a plastic injection molded part.

11. The limit level measurement device of claim 1, wherein the protective housing is attached to a fastening device of the limit level sensor by a separate fastening means.

12. The limit level measurement device of claim 1, wherein the protective housing has a distance of at least 10 millimeters in the axial direction apart from the mechanical oscillator.

13. The limit level measurement device of claim 1, further comprising an inner diameter of the protective housing or a distance between opposite side surfaces of the protective housing of at least 30 to 40 millimeters.

14. The limit level measurement device of claim 1, wherein the protective housing at least partially covers the mechanical oscillator.

15. The limit level measurement device of claim 9, wherein the protective housing is designed as a stamped-bent part.

16. The limit level measurement device of claim 13, wherein the inner diameter of the protective housing or distance between opposite side surfaces of the protective housing is 35 millimeters.

17. A protective housing for a mechanical oscillator of a limit level sensor of a limit level measurement device of claim 1.

18. The protective housing of claim 17, wherein the protective housing is a retrofit part.
